(19) United States
(12) Patent Application Publication
(10) Pub. No.: US 2015/0270048 A1
(43) Pub. Date: Sep. 24, 2015

(54) Molded Transformer

(71) Applicant: Hitachi Industrial Equipment Systems Co., Ltd., Tokyo (JP)

(72) Inventors: Kinya KOBAYASHI, Tokyo (JP); Masaki TAKEUCHI, Tokyo (JP); Atsushi SUZUKI, Tokyo (JP)

(21) Appl. No.: 14/621,645

(22) Filed: Feb. 13, 2015

(30) Foreign Application Priority Data
Mar. 18, 2014 (JP) 2014-054291

(51) Int. Cl. H01F 27/02

(52) U.S. Cl. CPC H01F 27/022

(57) ABSTRACT

As in a molded transformer installed in a seawater environment, it is necessary to improve corrosion resistance under environments in which air, a liquid, fine particles containing seawater attach to a stress buffer (silicone rubber or the like) in a connection part of a support structure and a coil. The connection part of the support structure and the coil of the molded transformer is coated with a material having higher corrosion resistance than a material in a gap of the connection part.

### BACKGROUND OF THE INVENTION

1. Field of the Invention

The present invention relates to a transformer partially or wholly molded with resin.

2. Description of the Related Art

Molded transformers have advantages in requiring less maintenance, and the future expansion of the application range is expected. Installation in unusual and special environments such as cold, hot, dry, humid environments is an example of the expansion of the application range. Even when the molded transformers are installed in the special environments, it is necessary to maintain reliability equal to the reliability under normal environments. JP-A-2000-25213 (Patent Document 1) is known as related art.

Under the special environments, it is necessary to maintain the reliability of the molded transformer equal to that in related art and, in some cases, it is necessary to make corrosion resistance under environments including seawater higher than ever.

In Patent Document 1, a coil and an upper surface of a stress buffer forming a holding structure in a molded transformer are coated with resin, however, coating on the stress buffer is partial only on the upper surface. Accordingly, when resistance of the stress buffer to seawater is weaker, a gas or liquid containing seawater attaches to the side surface of the stress buffer, and thereby, a problem of reduction in corrosion resistance of the stress buffer may arise.

### SUMMARY OF THE INVENTION

An object of the invention is, in a connection part of a support structure and a coil of a molded transformer, in a connection material in a gap of the connection part, to provide coating of a part in contact with a surrounding atmosphere with a coating material different from the connection material.

In a connection part of a support structure and a coil of a molded transformer, in a connection material in a gap of the connection part, a part in contact with a surrounding atmosphere is coated with a coating material different from the connection material. Further, a coating structure is formed using a material having higher corrosion resistance in at least one or more environments of seawater, volcanic ash, and polluted air than the connection material.

In addition, a thickness of the coating structure on one or both of an upper end and a lower end of the support structure is made larger than an average of thicknesses of the coating structure in the entire support structure. Further, at least a part having a continuously or smoothly increasing width of the support structure is provided in one or both of an upward direction and a downward direction of the support structure.

In addition, the coating structure is detachable. In addition, the coating structure is connected to the support structure using at least one or more methods using an adhesive, a bolt, and a spring. Further, the number of the coating structures is at least two or more.

In addition, the connection material includes at least one of silicone rubber and rubber. Further, the coating structure is formed using at least one material of epoxy resin, polyamide-imide, polyester, and polyester-imide.

In a connection part of a support structure and a coil of a molded transformer, in a connection material in a gap of the connection part, a part in contact with a surrounding atmosphere is coated with a coating material different from the connection material. Further, a coating structure is formed using a material having higher corrosion resistance in at least one or more environments of seawater, volcanic ash, and polluted air than the connection material, and thereby, attachment of highly corrosive gas, liquid, or particles to the connection part may be reduced and reliability of the molded transformer under a special environment may be maintained.

A thickness of the coating structure on one or both of an upper end and a lower end of the support structure is made larger than an average of thicknesses of the coating structure in the entire support structure. Further, at least a part having a continuously or smoothly increasing width of the support structure is provided in one or both of an upper end and a lower end of the support structure. Thereby, the thickness of the coating structure may be increased in the part with reduced corrosion resistance, and diffusion of highly corrosive gas, liquid, or particles from the coating structure surface to the inside may be efficiently suppressed. Therefore, the reliability of the molded transformer under a special environment may be further improved and the electric field/stress in the connection part may be reduced.

Furthermore, the coating structure is detachable. In addition, the coating structure is connected to the support structure using at least one or more methods using an adhesive, a bolt, and a spring. Further, the number of the coating structures is at least two or more. Thereby, when the corrosion resistance is lower, it is necessary to replace only the coating structure, and the replacement cost due to corrosion may be minimized.

### BRIEF DESCRIPTION OF THE DRAWINGS

FIG. 1 shows a primary coil and a support structure supporting the coil of a molded transformer for explanation of an example of the invention.

FIG. 2 is an enlarged view of a connection part of the coil and a holding structure.

FIG. 3 is a schematic view of the molded transformer coated with an insulating sheet of epoxy resin for explanation of the example of the invention.

FIG. 4 is an enlarged view of a connection part of a coating structure in FIG. 3.

FIG. 5 is an enlarged view of the connection part of the coating structure in FIG. 3.

FIG. 6 shows a support structure of a molded transformer.

FIG. 7 shows a support structure of a molded transformer.

FIG. 8 shows a support structure of a molded transformer.

### DETAILED DESCRIPTION OF THE EMBODIMENTS

### Example 1

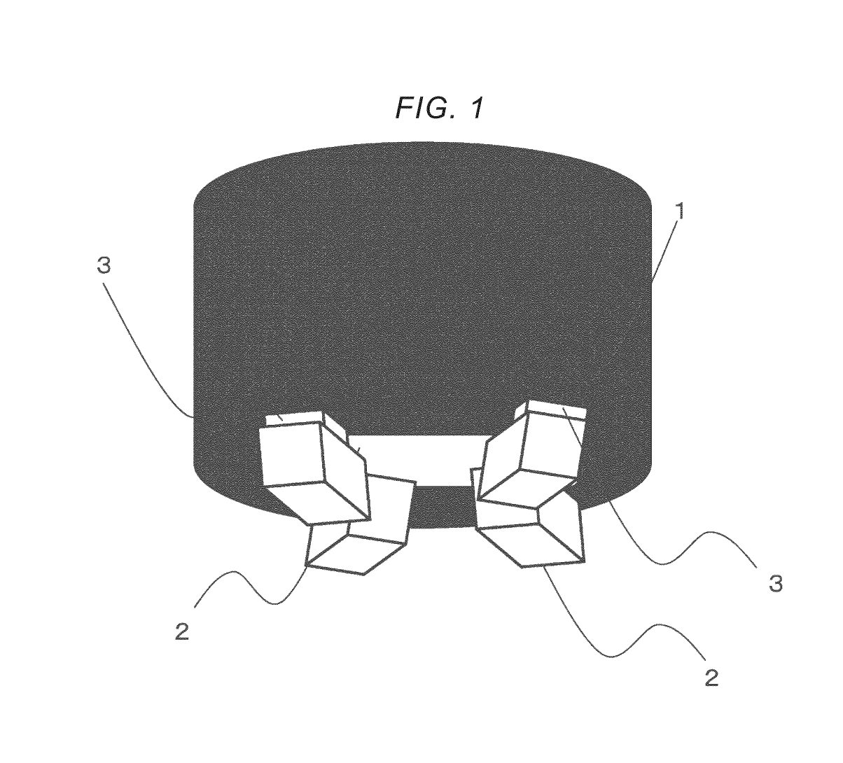

As below, the first example of the invention will be explained using FIGS. 1 to 5. The following drawings show schematic views and it should be noted that the relations between thicknesses and planar dimensions, ratios among respective layer thicknesses, etc. differ from actual ones. Accordingly, the specific thicknesses and dimensions should be understood in consideration of the following explanation. Further, obviously, in some parts, the relations and the ratios among dimensions may differ between the drawings.

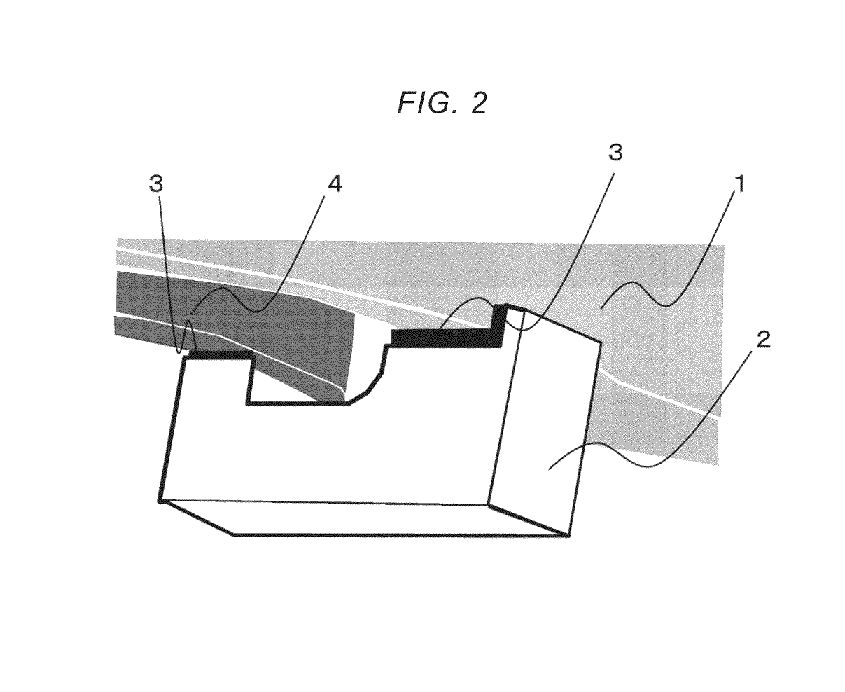

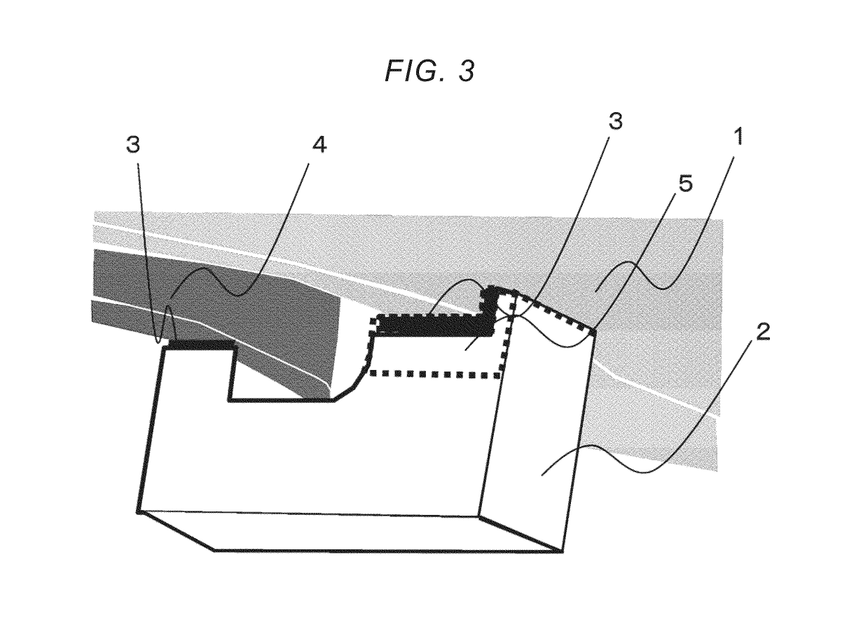

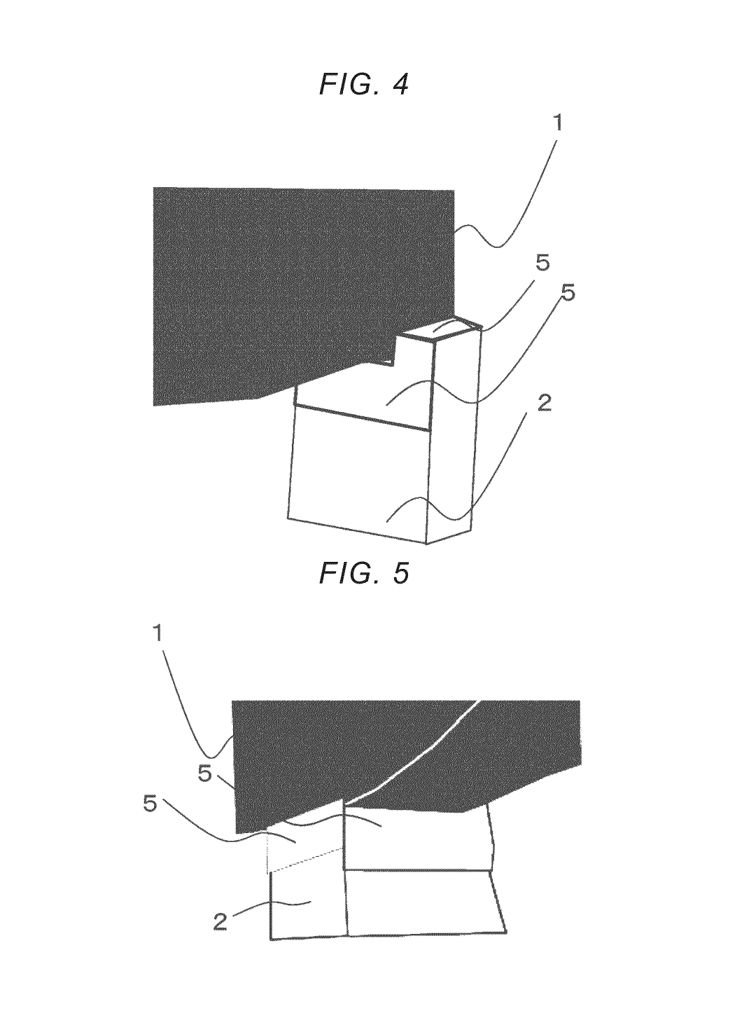

FIG. 1 shows a primary coil and a support structure supporting the coil, and a stress buffer that relaxes stress in a connection part in a molded transformer. The stress buffer serves to relax stress on the coil and the support structure. The stress is generated when the resin is expanded and compressed due to temperature rise and rapid cooling or when a major load is externally applied. Here, the stress buffer is silicone rubber. FIG. 2 is an enlarged view of a connection part of the coil and a holding structure. From a three-dimensional electric field analysis in an analysis system of FIG. 2, it was found that a large electric field is applied to a corner part of the stress buffer. It was also found that, when the molded transformer is installed under a normal environment, the corrosion resistance of the silicone rubber is not lower, however, when the molded transformer is installed in an atmosphere containing seawater, the corrosion resistance is lower. Accordingly, as shown in FIGS. 3, 4, 5, all of the parts in which the silicone rubber is directly exposed to the seawater atmosphere are coated with epoxy resin having higher corrosion resistance to the atmosphere containing seawater. The parts not shown in FIGS. 3, 4, 5 in which the stress buffer is exposed to the seawater atmosphere are also coated with epoxy resin. In the example, an insulating sheet of epoxy resin is used for coating as shown in FIG. 3. FIGS. 4 and 5 are enlarged views of a connection part of a coating structure, and it is known that the connection part is coated with the insulating sheet. Thereby, it was found that direct attachment of air, a liquid, particles containing seawater to the silicone rubber is suppressed. Therefore, reliability of the molded transformer under the special environment containing seawater may be maintained. Further, the epoxy resin is divided into pieces and fastened to the support structure with an adhesive. Thereby, the coating resin is detachable and, even when corrosion is caused in the coating material, it is necessary to replace only a part of the coating structure. Therefore, the replacement cost may be reduced. Furthermore, the resin is divided into pieces, and thus, only the corroded part may be replaced and the replacement cost may be reduced compared to the case of a single coating structure. The stress buffer used here is the silicone rubber, however, elastomer, rubber, or mixture of them may be used. Further, the coating material is the epoxy resin, however, polyamide-imide, polyester, polyester-imide, or mixture of them may be used.

### Example 2

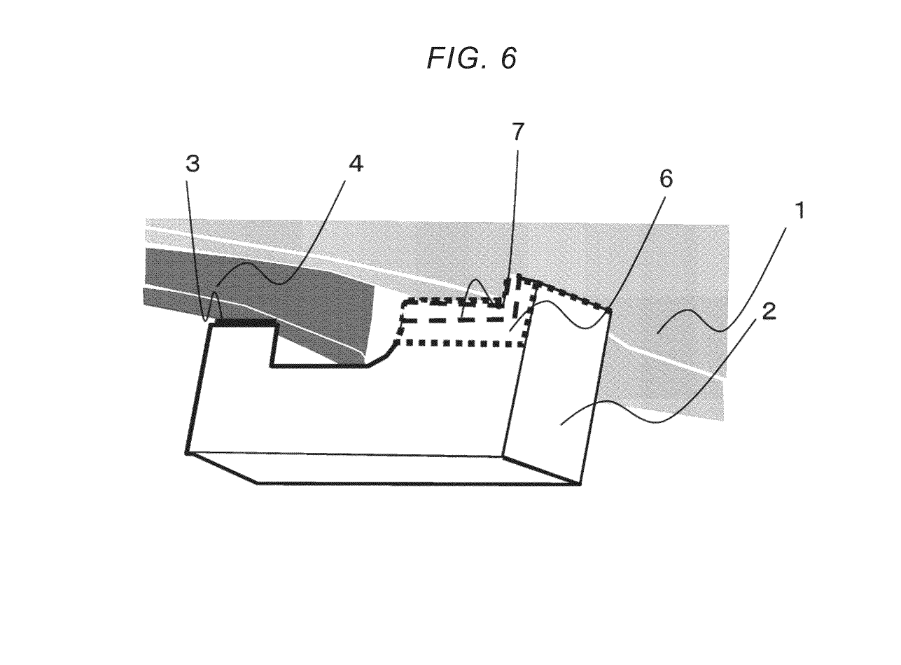

As below, the second example of the invention will be explained using FIGS. 1, 2, 6. In FIG. 6, an insulating sheet 2 is bonded onto an insulating sheet 1 of epoxy resin as a coating structure in a connection part of the coil and the support structure. The thickness of the coating structure on the holding structure is thicker in the part of the insulating sheet 2. Thereby, the air, the liquid, the fine particles containing seawater are not in direct contact with the silicone rubber of the stress buffer and the thickness of the upper part of the stress buffer is larger. Accordingly, compared to example 1, the time for the air, the liquid, the particles containing seawater to reach the silicon rubber inside from the coating structure surface may be made longer. When the thicknesses of the insulating sheet 1 and the insulating sheet 2 are the same, the time for the air, the liquid, the particles containing seawater to reach the silicon rubber inside from the coating structure surface may be improved to double. Thereby, the reliability of the molded transformer under the special environment containing seawater may be made higher than that in example 1. Furthermore, when the corrosion resistance of only the insulating sheet 2 is lower, it is necessary to replace only the insulating sheet 2 and the replacement cost may be made lower than that in example 1. The insulating sheet is similarly bonded onto the insulating sheet in the other parts of the stress buffer exposed to the air, and thereby, the effect may be further increased.

In the example, the insulating sheet is bonded onto the insulating sheet. When an insulating sheet 3 is further bonded to the coil side onto the insulating sheet 2, the time for the air, the liquid, the particles containing seawater to reach the stress buffer inside from the coating structure surface may be made further longer. Here, the three insulating sheets are used, however, four or more insulating sheets in any size and thickness may be used.

### Example 3

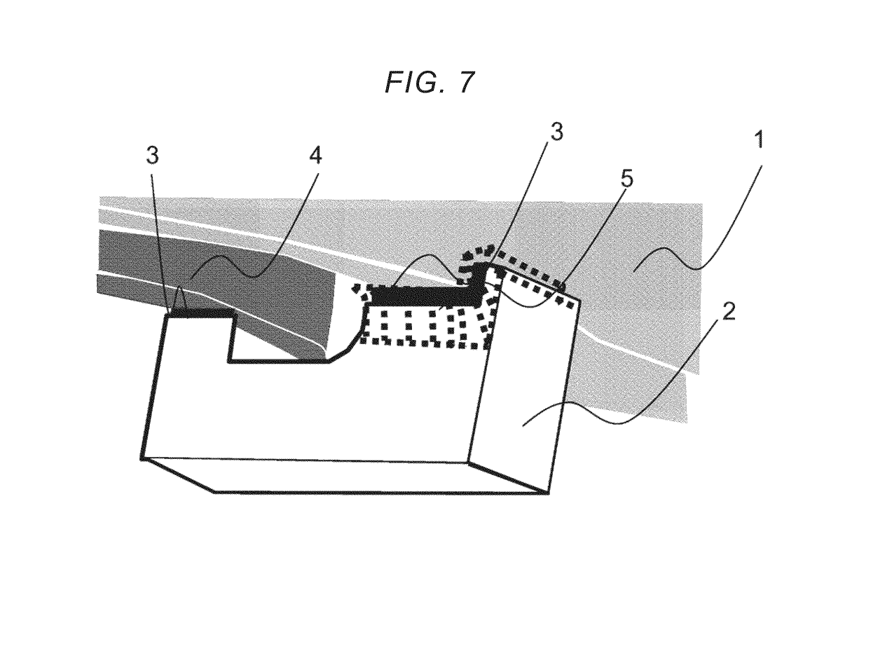

As below, the third example of the invention will be explained using FIGS. 1, 2, 7. In FIG. 7, the connection part of the coil and the support structure is molded using epoxy resin. Further, as shown in FIG. 7, the thickness of the coating structure is smoothly changed in the connection part with the stress buffer and the thickness in the upper part of the stress buffer is maximized. Thereby, compared to examples 1, 2, the time for the air, the liquid, the fine particles containing seawater to reach the silicone rubber inside from the coating structure surface may be made longer. Therefore, the reliability of the molded transformer under the special environment containing seawater may be made higher than that in examples 1, 2. Furthermore, the stress and the electric field may be reduced. It was found that, from three-dimensional electric field and stress calculation, the electric field and the stress may be reduced by 20% in the structure of example 3 compared to those in example 1.

The coating structure is connected to the support structure with an adhesive or fastened with bolts and nuts and detachable. Thereby, only the part with reduced corrosion resistance may be replaced in the parts of the coating structure. Further, the structure in FIG. 7 may be formed by superimposition of a plurality of insulating sheets. The stress buffer used here is the silicone rubber, however, elastomer, rubber, or mixture of them may be used. Further, the coating material is the epoxy resin, however, polyamide-imide, polyester, polyester-imide, or mixture of them may be used.

### Example 4

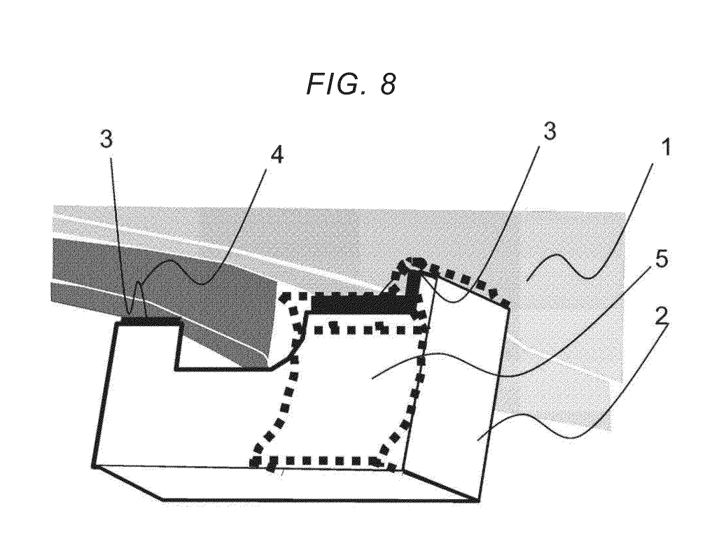

As below, the fourth example of the invention will be explained using FIGS. 1, 2, 8. In FIG. 8, the connection part of the coil and the support structure is molded using epoxy resin. In example 4, as shown in FIG. 8, the upper half of the coating structure is the same as that of example 3. Accordingly, like example 3, the time for the air, the liquid, the fine particles containing seawater to reach the silicone rubber inside from the coating structure surface may be made longer. Thereby, the reliability of the molded transformer under the special environment containing seawater may be made higher than that in examples 1, 2. In addition, from three-dimensional electric field and stress calculation, the stress and the electric field may be reduced by about 10% compared to those in example 3. Further, a structure recessed at the center of the support structure as shown in FIG. 8 may be provided on another surface or all surfaces of the support structure, and thereby, the electric field and the stress may be further reduced and the reliability of the molded transformer may be improved.

1. A molded transformer comprising:
a support structure; and
a coil,
wherein a part in contact with a surrounding atmosphere in a connection material in a gap in a connection part of the support structure and the coil is coated with a coating material different from the connection material.

2. The molded transformer according to claim 1, wherein the coating material has higher corrosion resistance in at least one or more environments of seawater, volcanic ash, and polluted air than the connection material.

3. The molded transformer according to claim 1, wherein a thickness of a coating structure on one or both of an upper end and a lower end of the support structure is made larger than an average of thicknesses of the coating structure in the entire support structure.

4. The molded transformer according to claim 3, wherein at least a part having a continuously or smoothly increasing width of the support structure is provided in one or both of an upward direction and a downward direction of the support structure.

5. The molded transformer according to claim 1, wherein the coating structure is detachable.

6. The molded transformer according to claim 5, wherein the coating structure is connected to the support structure using at least one or more methods using an adhesive, a bolt, and a spring.

7. The molded transformer according to claim 5, wherein the number of the coating structures is at least two or more.

8. The molded transformer according to claim 1, wherein the connection material includes at least one of silicone rubber and rubber.

9. The molded transformer according to claim 1, wherein the coating structure is formed using at least one material of epoxy resin, polyamide-imide, polyester, and polyester-imide.

10. The molded transformer according to claim 1 applied to a power generator, a substation, a railroad, transmission and transformation, and receiving and distribution.
